(19) United States
(12) Patent Application Publication
(10) Pub. No.: US 2006/0089866 A1
(43) Pub. Date: Apr. 27, 2006

(54) Computer system for exchanging workflows and methods thereof

(75) Inventors: Tsz Simon Cheng, Grand Prairie, TX (US); Gregory P. Fitzpatrick, Keller, TX (US); Daniel Hassell, Flower Mound, TX (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 10/974,151

(22) Filed: Oct. 27, 2004

(51) Int. Cl. G05B 19/418

(52) U.S. Cl. 705/8

(57) ABSTRACT

A computer-readable storage medium (100) for exchanging workflows (112), said workflows (112) presented by way of a graphical user interface (GUI) (102), the storage medium (100) comprising computer instructions for selecting (502) at least one workflow (112) from a plurality of workflows, and associating (506) the at least one workflow (112) with at least one target user (204) selected (504) from a plurality of target users (202).

### FIELD OF THE INVENTION

This invention relates generally to computer systems, and more particularly to a computer system for exchanging workflows and methods thereof.

### BACKGROUND OF THE INVENTION

Modern business processes are becoming increasingly complex and often require cooperation among workers scattered both within a given enterprise and across enterprise boundaries. Conventional workflow software products to enable these business processes are focused on tying together disparate enterprise systems and presenting a consolidated, end-to-end workflow for users of such systems. These products, however, are unable to adequately address dynamic changes in work conditions in a complex multi-user environment. For instance, when a user unexpectedly calls in sick, it is very cumbersome to reassign workflows to other users using a workflow system.

### SUMMARY OF THE INVENTION

Embodiments in accordance with the invention provide a computer system and method for exchanging workflows between users.

In a first embodiment of the present invention, a method of exchanging workflows in a computer system that presents said workflows using a graphical user interface (GUI), includes the steps of selecting at least one workflow from a plurality of workflows, and associating the at least one workflow with at least one target user selected from a plurality of target users.

In a second embodiment of the present invention, a method of exchanging workflows in a computer system that presents said workflows using a graphical user interface (GUI), includes the steps of selecting a first workflow and a second workflow from a plurality of workflows, and associating the first workflow with a first target user and the second workflow with a second target user, said first and second target users selected from a plurality of target users.

In a third embodiment of the present invention, a computer-readable storage medium for exchanging workflows, said workflows presented by way of a graphical user interface (GUI), includes computer instructions for selecting at least one workflow from a plurality of workflows, and associating the at least one workflow with at least one target user selected from a plurality of target users.

### BRIEF DESCRIPTION OF THE DRAWINGS

FIGS. 1-3 are illustrations of a presentation by a computer system for graphically and textually exchanging workflows, respectively.

FIG. 4 illustrates of a prompt for delegating a workflow.

FIG. 5 is a flow chart illustrating a method for exchanging workflows in a computer-readable storage medium.

### DETAILED DESCRIPTION OF THE DRAWINGS

While the specification concludes with claims defining the features of embodiments of the invention that are regarded as novel, it is believed that the embodiment of the invention will be better understood from a consideration of the following description in conjunction with the figures, in which like reference numerals are carried forward.

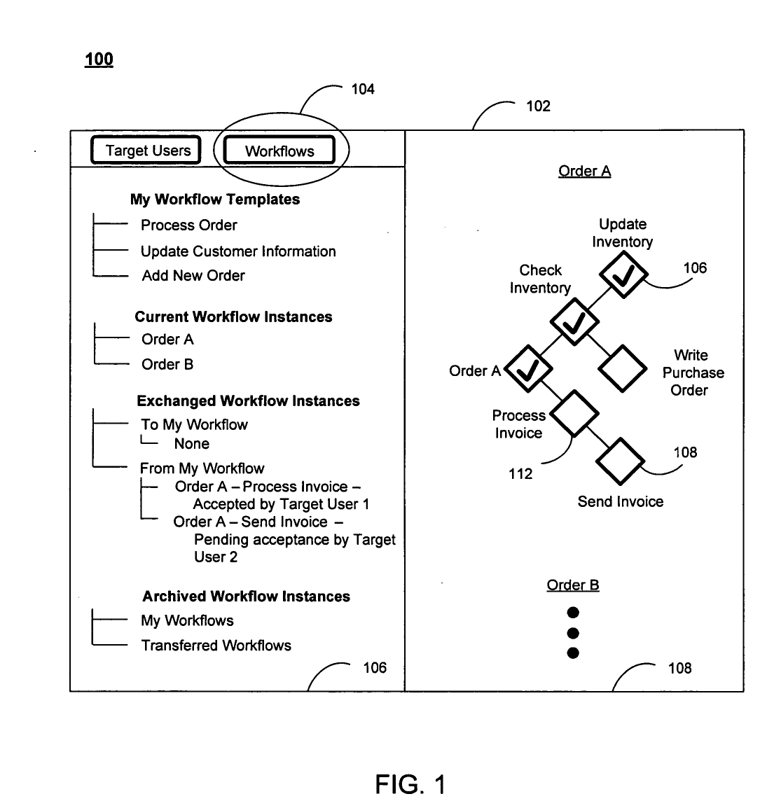

FIGS. 1-3 are illustrations of a presentation by a computer system 100 for graphically and textually exchanging workflows, respectively. Each user of the computer system 100 is presented with a graphical user interface 102 (GUI 102). The presentation formats for the GUI 102 in FIGS. 1-3 are illustrative and not intended to be limiting of the claims below. For instance, drop-down menus could be replaced with graphical representations, while the workflows could be presented in a separate cascaded or tiled window. Accordingly all modifications to the GUI 102 of FIGS. 1-3 in addition to any combination of presentation methods which provide a function, way and result equivalent to the aforementioned description is intended to be within the scope of the claims included herein.

The computer system 100 is realized from a typical combination of hardware and software with a computer program that, when being loaded and executed, controls the computer system 100 such that it carries out the functions described herein. The computer system 100 can use any kind of processor, server, mainframe or other apparatus singly or in combination adapted for carrying out the functions of the claims below. Additionally, the computer system 100 may be centralized in one processor or mainframe, or distributed where different elements are spread across several interconnected computers or workstations.

For purposes of illustration only, the computer system 100 will comprise a server, and a plurality of conventional computer terminals coupled to each other by way of conventional networking means (e.g., wired or wireless Ethernet). The server will operate an instance of workflow software operating in accordance with the claims below. Each of the plurality of computer terminals will have access to the server for acting on the software operating therein. It would be understood by one of ordinary skill in the art that other software or hardware configurations are possible without changing the scope of the invention described herein.

In FIG. 1, the GUI 102 window is subdivided into two workspaces 106-108. The workspace 106 to the left presents a textual work environment including Workflow Templates, Current Workflow Instances, status of Exchanged Workflow Instances, and Archived Workflow Instances. The Workflow Templates may be used for Processing Order(s), updating Customer Information and establishing New Orders. The Current Workflow Instances outlines current orders in process (illustrated by way of example as Orders A & B). The status of Exchanged Workflow Instances illustrates workflows that have been assigned to a source user and workflows the source user has assigned to target users.

For the purposes of describing the exchange of workflows within the computer system 100 environment, the term “source user” refers to a user operating from one of the computer terminals of the computer system 100 that submits workflows to “target users”. The term “target users”, on the other hand, refers to a recipient user of the workflows submitted by the source user who is operating on a different computer terminal of the computer system 100. The terms “source user” and “target user” are interchangeable depending on who is submitting workflows and who is receiving the submitted workflows, respectively.

Additionally, the terms “target user(s)” and “source user(s)” may take the form of individuals, enterprises and/or services. Target users serving as individuals may be within the same company or firm as the source user, or contracted or sub-contracted firms or companies. Similarly, target users may be enterprises or services. For instance, a target user may be a supply enterprise that is solicited by the source user to complete a workflow task 112 (e.g., deliver supplies to a destination). Alternatively, target users may be service organizations such as temporary employment service firms. In this case, a workflow may be assigned to someone or several employees in the firm according to the complexity of the delegated task 112.

It should be evident that source users and/or target users may take on many embodiments which do not change the operability of the invention. These embodiments, along with all modifications and additions, are intended to be within the scope of the claims included herein.

In the illustration of FIG. 1, no workflows have been assigned to the source user, while the source user has requested assignment of two workflows: one to Target User 1 (Process Invoice) who has accepted the source user's delegation, and the other to Target User 2 (Send Invoice) who has yet to accept the source user's delegation. In the descriptions below, the term “workflow(s)” refers to partial or whole Orders. To distinguish partial Orders, the term “workflow task(s)” or “task(s)” will be used to refer to sub elements of the Order. These terms will be used interchangeably and are considered equivalents throughout the description of the invention.

Continuing with FIG. 1, the source user has delegated workflow tasks 112 to Target Users 1 & 2 which comprise a portion of Order A. Alternatively, the source user may delegate entire workflows 112 such as, for example, delegating Order A to Target User 1 and Order B to Target User 2, or any task and/or workflow combination thereof. The Archived Workflow Instances outline the workflows archived by the source user and workflows transferred to target users.

Workspace 108 presents Order A graphically. Order B is assumed to be out of the GUI 102 screen range and therefore not shown for this illustration. There are many methods, however, for displaying multiple workflow views (i.e., Orders). For instance, one workflow view could be presented at a time. This may be accomplished by selecting a workflow view from a drop-down menu of workspace 108 to view any one of Orders A or B. Alternatively, all workflow views for each Order can be presented in workspace 108 with a vertical scroll bar when workflows fall outside the presentation range of the GUI 102 (such as is the case for Order B).

Continuing with Order A, this order comprises a plurality of workflows 112 with accompanying descriptions starting from a root workflow for Order A. Any other equivalent structure for presenting workflows may be used in accordance with the invention. When a target user or source user completes a workflow tasks 112, a checkmark 106 is superimposed graphically on the task 112 to inform the source or target users that the task 112 has been completed. Uncompleted tasks 108 remain unchecked. It should be noted that other conventional methods for presenting status of a workflow 112 may be used and are intended to be within the scope of the claimed invention.

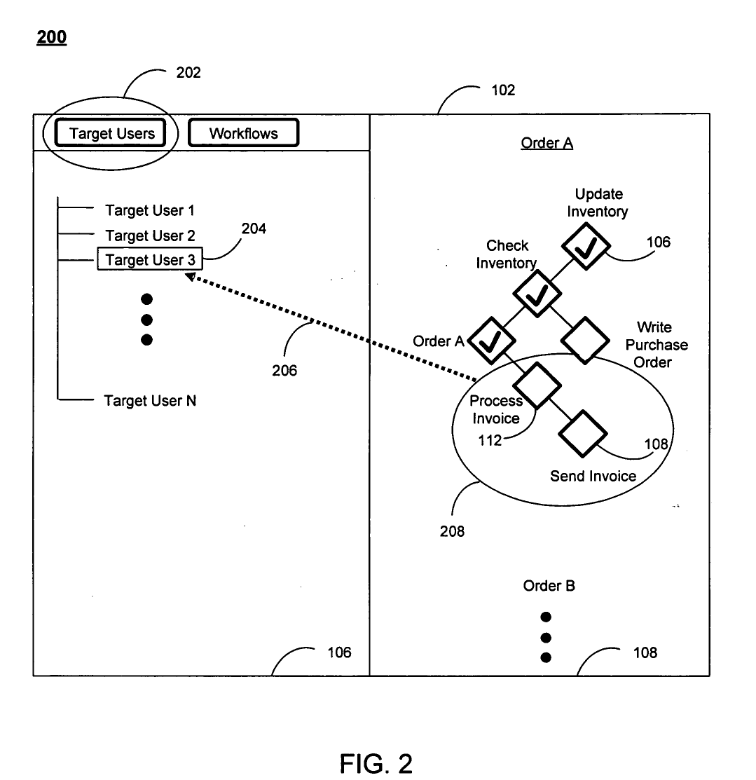

FIG. 2 illustrates how a source user selects and associates graphically a workflow 112 in workspace 108 with a target user chosen from a plurality of target users via a pull-down menu in workspace 106. From this illustration, a source user selects a target user 204 (shown as Target User 3) and a workflow combination 208 comprising two workflow tasks 112 (Process Invoice and Send Invoice) using a conventional computer mouse, and performs an association 206 by dragging and dropping the workflow combination 208 onto the target user 204. The foregoing graphical drag and drop action is liken to drag and drop actions inherent in conventional software applications such as Microsoft Windows.

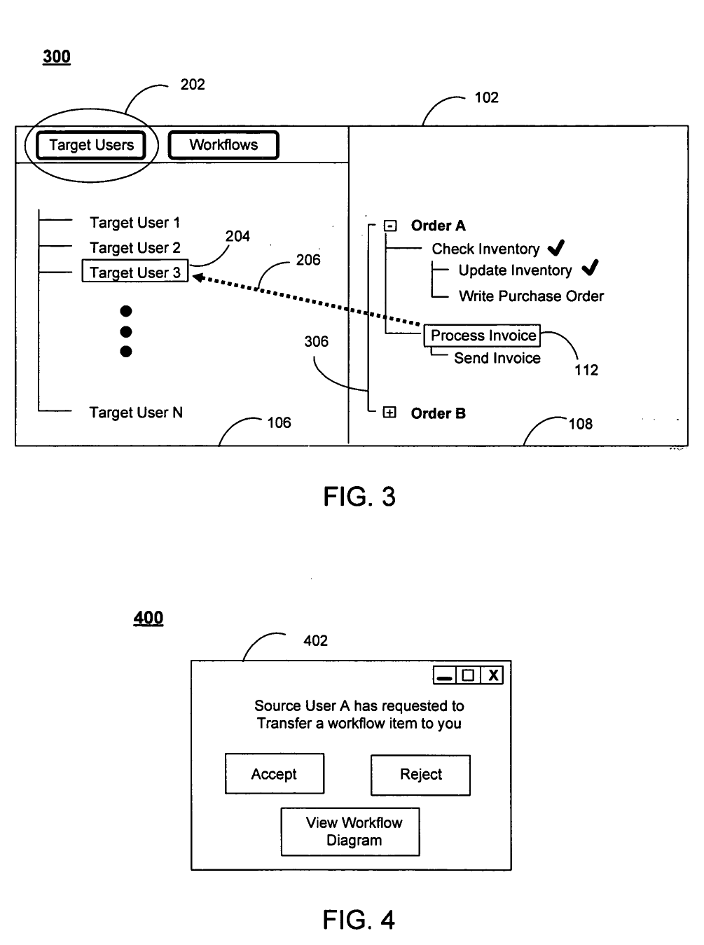

FIG. 3 illustrates an alternative embodiment for associating a textual presentation 306 of workflows 112 with a target user 204. Similar to FIG. 2, a source user performs an association 206 of a workflow task 112 (Process Invoice) selected graphically by the source user with a target user 204 by way of a drag and drop action as described above.

It would be appreciated by one of ordinary skill in the art that the association action 206 of FIGS. 2 and 3 may be performed by other conventional means not limited to a drag and drop method. For example, association may be performed by selecting a workflow task 112 using a conventional mouse, which in turn initiates a new GUI window providing a list of target users to select from. Accordingly, any method for associating one or more target users 204 with one or more workflows 112 which provides a function, way and result equivalent to the aforementioned description is intended to be within the scope of the claimed invention.

The association action described above leads to the establishment of communications between the source user's computer terminal and the target user 204 operating at a separate computer terminal. This communication results in a submission of the workflow tasks 112 to the target user 204, which in turn prompts the target user 204 to respond to a request from the source user for delegating the workflow 112 to the target user 204. This prompt is illustrated graphically in FIG. 4.

In FIG. 4 the target user 204 sees a new GUI window 402 indicating that a workflow 112 has been delegated, and requests the target user 204 to respond. The response may be any number of potential responses relevant to the source user. In the example of FIG. 4, the response is a simple acceptance or rejection of the delegation. To assist the target user 204 in determining the response, a soft button (View Workflow Diagram) is provided with the prompt 402 to review the delegated workflow 112.

A prompt may be submitted to the target user 204 using other conventional communication means such as e-mail, or instant messaging. In addition, other responses of substantive value to a source user may be used. For example, a target user 204 may not want to reject or accept the delegation. Instead a target user 204 may choose to response to a suggestion for forwarding the delegation to another target user. At which point, the source user may either pursue the suggestion for re-delegation or not.

Alternatively, the prompt and corresponding response may take the form of an exchange between the target user 204 and the source user such as, for example, a request for more information about the delegated workflow 112 so that the target user 204 can make an informed decision. Once the information is analyzed, the target user 204 may want to, for example, negotiate, counter-propose, tentatively accept, propose a different delivery time, accept or reject the delegated workflow task 112, or combinations thereof. In an enterprising environment such as, for example, a bidding auction service (e.g., EBAY™) or temp service, the response may be bidding offers from one or more service organizations, which in turn prompts the source user to select from the bidding offers before any one target user 204 is allowed to execute the delegated workflow task 112.

It should be evident from the embodiments above, that response or prompts may take many forms while remaining operable according to the invention described herein. Accordingly, all such prompts and responses whether applied in real-time or non-real-time are intended to be within the scope and spirit of the claims below.

Included in the workflow software operating on the server of the computer system 100 is a workflow database for tracking changes in state of workflows 112. Upon receiving a response from the target user 204 and/or completing a workflow task 112 the workflow database will be updated. In addition, the GUI 102 will be updated to reflect these updates. For example, when a workflow task 112 is completed by a target user 204, a checkmark 106 is shown to convey completion of the task to all users of the computer system 100. Similarly, when a target user 204 accepts or rejects the delegated workflow 112, the GUI 102 reflects the state of the delegation textually by way of the Exchanged Workflow Instances menu in workspace 106.

In an alternative embodiment to the aforementioned embodiments, a source user selects first and second workflows, which the source user then associates with first and second target users. Processing the second workflow by the second target user depends on completion of the first workflow by the first target user. Accordingly, when the second target user accepts the delegation of the second workflow, the second target user must wait until the first target user has completed the first workflow task.

As in previous embodiments, a workflow database tracks all changes of state in the workflow. Once the workflow database detects the first target user has completed the first workflow, a notification is sent to the second target user to alert the target user that the second workflow is available for processing. Completion may be signaled by any number of conventional notice mechanisms such as, for example, e-mail, over the air paging, or updates to the GUI 102 such as the checkmark 106 of a workflow task 112.

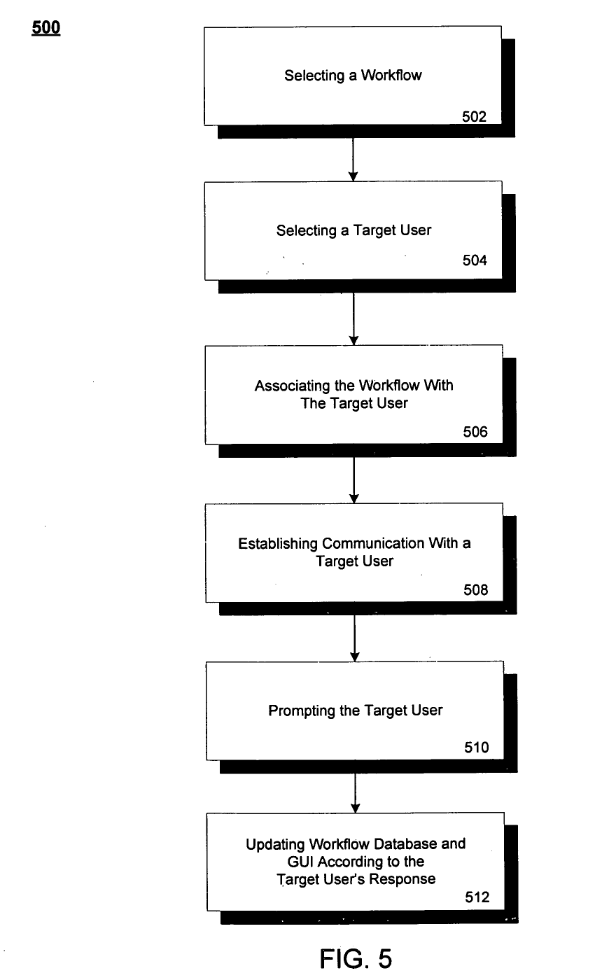

FIG. 5 is a flow chart illustrating a method for exchanging workflows in a computer-readable storage medium equivalent to the computer system 100 described herein. The computer-readable storage system 100 includes computer instructions beginning with step 502 for selecting at least one workflow 112 from a plurality of workflows 110. The selection process may be performed graphically or textually as described in FIGS. 2 and 3. In steps 504-506 the at least one workflow is associated with at least one target user selected from a plurality of target users 202. Any selection and association order between the target user 204 and the workflow 112 may be used in the present invention.

In step 508, communications in the computer system 100 is established between the computer terminal of the target user 204 and the computer terminal of the source user who initiated the association instruction. In step 510, the target user 204 is prompted to respond to a request for delegating the workflow 112 to the target user 204. In step 512, a workflow database operating on the computer system 100 is updated with the response provided by the target user 204. Similarly, the GUI 102 presented to the source user and the target user 204 is updated to reflect the response of the target user 204.

In light of the foregoing description, it should be recognized that embodiments in the present invention could be realized in hardware, software, or a combination of hardware and software. These embodiments could also be realized in numerous configurations contemplated to be within the scope and spirit of the claims below.

It should also be understood that the claims below are intended to cover the structures described herein as performing the recited functions and not only structural equivalents. For example, although the textual and graphical representations of workflows 112 described in FIGS. 2 and 3 may not be structural equivalents in that a textual representation employs text, whereas a graphical representation employs diagrams, textual and graphical representations of workflows 112 are equivalent structures in that both convey equivalent information. The claims that follow are therefore sufficiently general to include equivalent structures.

What is claimed is:

1. A method of exchanging workflows in a computer system that presents said workflows using a graphical user interface (GUI), comprising the steps of:
selecting at least one workflow from a plurality of workflows; and
associating the at least one workflow with at least one target user selected from a plurality of target users.

2. The method of claim 1, further comprising the steps of:
establishing communication between a source user who initiated the association step and the at least one target user; and
submitting the at least one workflow to the at least one target user.

3. The method of claim 2, further comprising the step of prompting the at least one target user to respond to a request for delegating the at least one workflow to the at least one target user.

4. The method of claim 3, further comprising the step of updating a workflow database comprising the plurality of workflows and the GUI presented to the source user and the at least one target user according to the response provided by the at least one target user.

5. The method of claim 1, further comprising the step of presenting the plurality of workflows graphically.

6. The method of claim 1, further comprising the step of presenting the plurality of workflows textually.

7. The method of claim 1, further comprising the steps of:
selecting the at least one workflow graphically as presented by the GUI; and
associating the graphical selection with the at least one target user.

8. The method of claim 1, further comprising the steps of:
selecting the at least one workflow textually as presented by the GUI; and
associating the textual selection with the at least one target user.

9. A method of exchanging workflows in a computer system that presents said workflows using a graphical user interface (GUI), comprising the steps of:
selecting a first workflow and a second workflow from a plurality of workflows; and
associating the first workflow with a first target user and the second workflow with a second target user, said first and second target users selected from a plurality of target users.

10. The method of claim 9, further comprising the steps of:
establishing communication between the first and second target users and a source user who initiated the association step; and
prompting the first and second target users to respond to a corresponding first and second request for delegating the first and second workflows thereto.

11. The method of claim 10, further comprising the step of updating a workflow database comprising the plurality of workflows and the GUI presented to the source user and the first and second users according to the response provided by the first and second users.

12. The method of claim 9, wherein the second workflow depends on completion of the first workflow, and wherein the second target user is prompted when the first workflow has been completed by the first target user.

13. The method of claim 9, further comprising the steps of:
selecting the first and second workflows graphically as presented by the GUI; and
associating the graphical selection with the first and second target users.

14. The method of claim 9, further comprising the steps of:
selecting the first and second workflows textually as presented by the GUI; and
associating the textual selection with the first and second target users.

15. A computer-readable storage medium for exchanging workflows, said workflows presented by way of a graphical user interface (GUI), the storage medium comprising computer instructions for:
selecting at least one workflow from a plurality of workflows; and
associating the at least one workflow with at least one target user selected from a plurality of target users.

16. The computer-readable storage medium of claim 15, further comprising computer instructions for establishing communication between the at least one target user and a source user who initiated the association instruction.

17. The computer-readable storage medium of claim 16, further comprising computer instructions for prompting the at least one target user to respond to a request for delegating the at least one workflow to the at least one target user.

18. The computer-readable storage medium of claim 17, further comprising computer instructions for updating a workflow database comprising the plurality of workflows and the GUI presented to the source user and the at least one target user according to the response provided by the at least one target user.

19. The computer-readable storage medium of claim 15, further comprising computer instructions for:
selecting the at least one workflow graphically as presented by the GUI; and
associating the graphical selection with the at least one target user.

20. The computer-readable storage medium of claim 15, further comprising computer instructions for:
selecting the at least one workflow textually as presented by the GUI; and
associating the textual selection with the at least one target user.
